(19) United States
(12) Patent Application Publication
(10) Pub. No.: US 2010/0039365 A1
(43) Pub. Date: Feb. 18, 2010

(54) CHROMATIC LCD DEVICE AND METHOD THEREOF

(76) Inventors: Shyh-Yueh Wang, Taichung (TW); Chuen-Tzay Jean, Taichung City (TW); Chia-Hui Chen, Taichung County (TW); Chiu-Yuan Huang, Taichung City (TW); Yen-Liang Chen, Taichung County (TW); Wei-Jen Tang, Taichung City (TW); Chien-Chih Hsu, Changhua County (TW)

Correspondence Address: Muncy, Geissler, Olds & Lowe, PLLC, P.O. BOX 1364, FAIRFAX, VA, 22038-1364, US

(21) Appl. No.: 12/192,541

(22) Filed: Aug. 15, 2008

(51) Int. Cl. G02F 1/13357; G09G 3/36

(52) U.S. Cl. 345/102

(57) ABSTRACT

The present invention modulates a plurality of sequentially generated common voltage signals into a new common voltage signal and synchronous color-separation backlight control signals turning on different-color backlight sources. The new common voltage signals and segment voltage signals cooperate to form voltage differences making a mono-pixel allow different-color backlights to pass and controlling the mono-pixel to turn on or turn off in a time-division mode. The effects of the time-division different-color backlights are accumulated by vision persistence to form different colors on the mono-pixel. Thus, the present invention can enable a monochromatic LCD chip and a mono-pixel to present a multi-color effect.

### FIELD OF THE INVENTION

The present invention discloses an LCD device and a method thereof, particularly to an LCD device and a method thereof, which enables a monochromatic LCD panel and a single-level control driver to generate a multi-level chromatic effect without using a color filter.

### BACKGROUND OF THE INVENTION

All chromatic LCD (Liquid Crystal Display) devices need a color filter. In a chromatic LCD device, white backlight passes through a color filter to present red, green or blue on a single-color subpixel, and the lights of subpixels mix to present a desired color on the corresponding pixel. Most of the light is absorbed by the color filter. Therefore, the color filter has low light efficiency and generates a lot of heat. Further, the color filter is very expensive.

### SUMMARY OF THE INVENTION

The primary objective of the present invention is to provide a chromatic LCD (Liquid Crystal Display) device and a method thereof, which modulates at least two common voltage signals to sequentially a mono-pixel and turn on different-color backlights in a time-division mode, whereby the time-division different-color backlights are accumulated by vision persistence to present a multi-level chromatic effect on a mono-pixel.

The device of the present invention comprises a monochromatic LCD panel, a single-level driving controller, a multi-color backlight modulation device, and a multi-color modulation backlight unit. The monochromatic LCD panel has a common electrode and a plurality of segment electrodes, and the common electrode and the segment electrodes are respectively arranged on an upper layer and a lower layer. The single-level driving controller sequentially generates a plurality of common voltage signals and a plurality of segment voltage signals according to the timing. The multi-color modulation backlight unit has at least two different-color backlight sources. The multi-color backlight modulation device has a plurality of input junctions, an output junction and at least two backlight output control junctions, wherein the number of the backlight output control junctions is identical to the number of the different-color backlight sources. The multi -color backlight modulation device generates color-separation backlight control signals. The assembly of the input junctions is electrically coupled to the output junction.

The single-level driving controller is electrically coupled to the segment electrodes via a plurality of segment circuits. The single-level driving controller is electrically coupled to the input junctions of the multi-color backlight modulation device via a plurality of common circuits. The output junction of the multi-color backlight modulation device is electrically coupled to the common electrode via a common-assembly circuit. At least two backlight output control junctions are electrically coupled to at least two different-color backlight sources.

The single-level driving controller outputs a plurality of common voltage signals to the common electrode. The multi-color backlight modulation device modulates the common voltage signals and generates the color-separation backlight control signals. At least two backlight output control junctions output the color-separation backlight control signals to turn on at least two different-color backlight sources. The mono-pixel is driven to allow different-color backlights to pass through the mono-pixel in a time-division mode. The effects of the time-division different-color backlights are accumulated by vision persistence to present a multi-color effect.

### BRIEF DESCRIPTION OF THE DRAWINGS

FIG. 1 is a diagram schematically showing the electrodes of a monochromatic LCD panel according to the present invention;

FIG. 2 is a diagram schematically showing the LCD device according to the present invention;

FIG. 3 is a diagram schematically showing the multi-color modulation backlight unit according to the present invention;

FIG. 4 is a diagram showing the waveforms of the common voltage signals generated by a single-level driving controller according to the present invention;

FIG. 5 is a diagram schematically showing the function of a multi-color backlight modulation device according to the present invention; and

FIG. 6 is a diagram showing the waveforms of the common voltage signals having modulated by a multi-color backlight modulation device according to the present invention.

FIG. 7 is a diagram showing the waveforms of the common voltage signals having modulated by a multi-color backlight modulation device and drive different-color backlight sources according to the present invention.

### DETAILED DESCRIPTION OF THE PREFERRED EMBODIMENTS

Below, the technical contents of the present invention are described in detail in cooperation with the drawings.

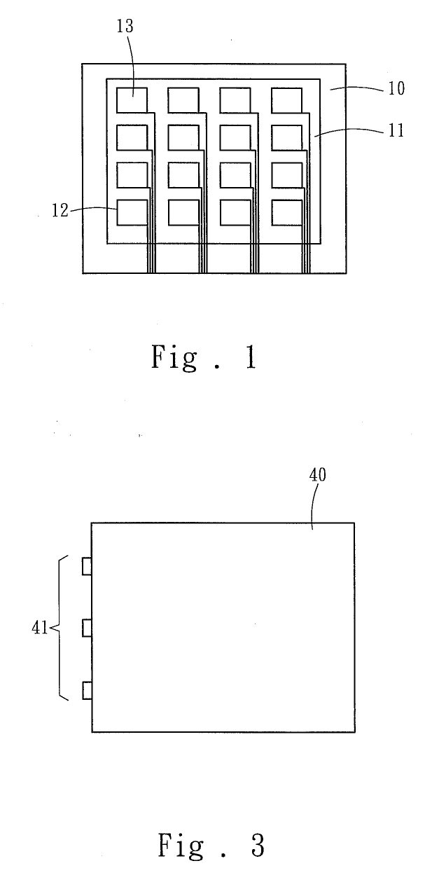

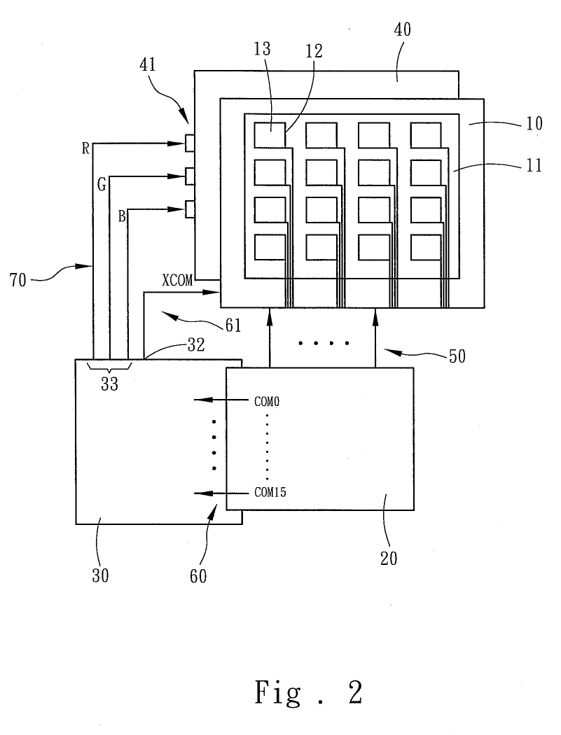

Refer to FIG. 1, FIG. 2 and FIG. 3. The device of the present invention comprises a monochromatic LCD (Liquid Crystal Display) panel 10, a single-level driving controller 20, a multi-color backlight modulation device 30, and a multi-color modulation backlight unit 40. The monochromatic LCD panel 10 has a common electrode 11 and a plurality of segment electrodes 12, and the common electrode 11 and the segment electrodes 12 are respectively arranged on an upper layer and a lower layer. The monochromatic LCD panel 10 also has a plurality of mono-pixels 13 corresponding to the coincidence points of the common electrode 11 and the segment electrodes 12. In FIG. 1, the monochromatic LCD panel 10 has 16 mono-pixels 13. The multi-color modulation backlight unit 40 has at least two different-color backlight sources 41, preferably red, green and blue backlight sources 41.

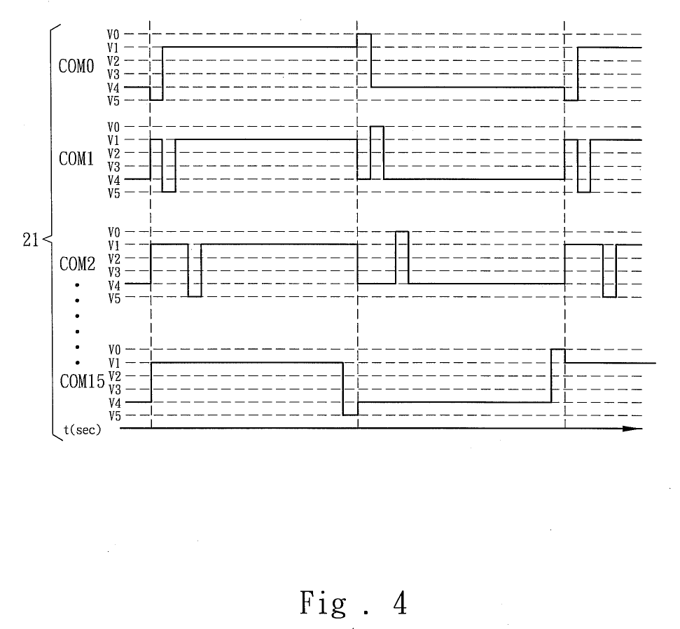

Refer to FIG. 4 also. The single-level driving controller 20 sequentially generates a plurality of common voltage signals 21 and a plurality of segment voltage signals (not shown in the drawings) according to the timing. The common voltage signals 21 may be common voltage signals 21 (COM0-COM15) having a duty cycle of 1/16. The segment voltage signals cooperate with the common voltage signals 21 to form voltage differences driving the mono-pixels 13.

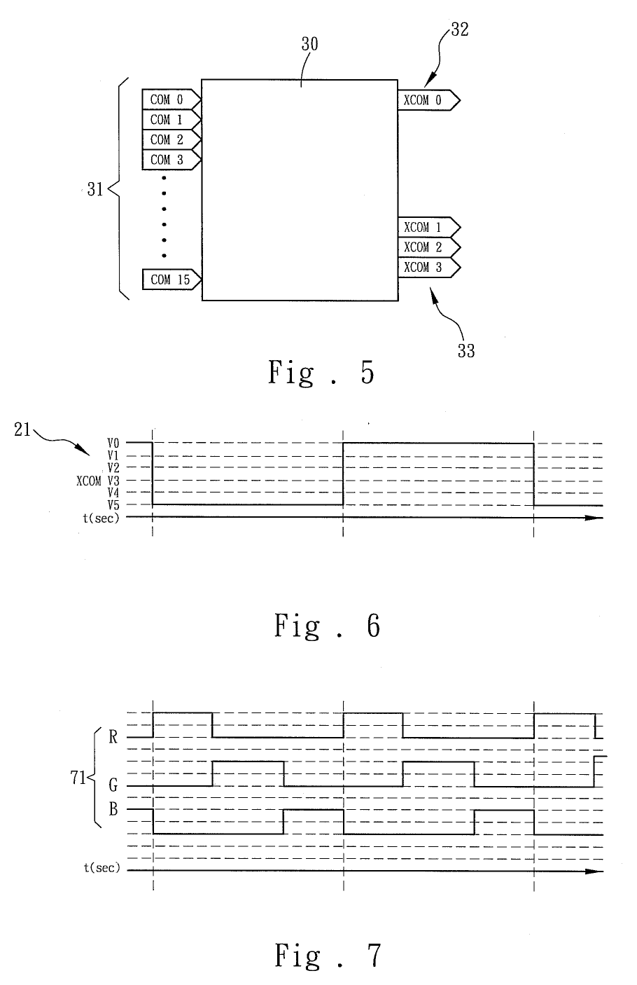

Refer to FIG. 5. The multi-color backlight modulation device 30 has a plurality of input junctions 31, an output junction 32 and at least two backlight output control junctions 33, wherein the number of the backlight output control junctions 33 is identical to the number of the different-color backlight sources 41. The multi-color backlight modulation device 30 generates color-separation backlight control signals 71. The assembly of the input junctions 31 (16 junctions in the drawing) is electrically coupled to the output junction 32. The multi-color backlight modulation device 30 has three backlight output control junctions 33 in the drawing. Refer to FIG. 2 again. The single-level driving controller 20 is electrically coupled to the segment electrodes 12 via a plurality of segment circuits 50. The single-level driving controller 20 is electrically coupled to the input junctions 31 of the multi-color backlight modulation device 30 via a plurality of common circuits 60. The output junction 32 is electrically coupled to the common electrode 11 via a common-assembly circuit 61. The backlight output control junctions 33 are electrically coupled to the backlight sources 41 of the multi-color modulation backlight unit 40 via a backlight drive circuit 70.

The method of the present invention comprises steps: preparing a monochromatic LCD panel 10, a single-level driving controller 20, a multi-color backlight modulation device 30, and a multi-color modulation backlight unit 40; electrically coupling the single-level driving controller 20 to the segment electrodes 12 via a plurality of segment circuits 50; electrically coupling the single-level driving controller 20 to the input junctions 31 of the multi-color backlight modulation device 30 via a plurality of common circuits 60; electrically coupling the output junction 32 to the common electrode 11 via a common-assembly circuit 61; and electrically coupling the backlight output control junctions 33 to the backlight sources 41 of the multi-color modulation backlight unit 40 via a backlight drive circuit 70.

Refer to FIG. 6 and FIG. 7. In the multi-color backlight modulation device 30, 16 input junctions 31 are assembled together and coupled to the output junction 32. Therefore, the mono-pixels 13 are driven by the waveforms of the common voltage signals 21 (XCOM) provided by the common-assembly circuit 61, as shown in FIG. 6. In other words, the pixels 13 are driven by 16 common voltage signals 21 in a time-division mode. Thus, the multi-color backlight modulation device 30 synchronously modulates the 16 time-division common voltage signals 21 to generate the color-separation backlight control signals 71. The color-separation backlight control signals 71 are output from the backlight output control junctions 33 to drive the different-color backlight sources 41 of the multi-color modulation backlight unit 40 via the backlight drive circuit 70, as shown in FIG. 7. Thus are generated backlights of different colors in a time-division mode. In this embodiment, the 16 common voltage signals 21 are distributed by a ratio of 5:6:5 to separately drive the multi-color modulation backlight unit 40 to generate backlights of red, green, blue and other colors.

In the present invention, the common voltage signals 21 and the segment voltage signals cooperate to generate voltage differences. The voltage differences drive a same mono-pixel 13 to turn on, turn off and allow different-color backlights to pass in a time-division mode. The effects of the time-division different-color backlights are accumulated by vision persistence to form different colors.

In conclusion, the multi-color backlight modulation device 30 outputs the sequentially generated common voltage signals 21 to control the common electrode 11. The common voltage signals 21 and the segment voltage signals cooperate to turn on and turn off the mono-pixel 13 in a time-division mode. The multi-color backlight modulation device 30 also outputs the common voltage signals 21 from the backlight output control junctions 33 to drive the different-color backlight sources 41 of the multi-color modulation backlight unit 40 in a time-division mode via the backlight drive circuit 70. The effects of the time-division different-color backlights are accumulated by vision persistence to form different colors. Brief to speak, the present invention uses the multi-color backlight modulation technology to make the monochromatic LCD panel and the single-level control driving chip able to present a multi-color effect.

What is claimed is:

1. A chromatic liquid crystal display device comprising
a monochromatic LCD (Liquid Crystal Display) panel having a common electrode and a plurality of segment electrodes, wherein said common electrode and said segment electrodes are respectively arranged on an upper layer and a lower layer;
a single-level driving controller sequentially generating a plurality of common voltage signals and a plurality of segment voltage signals according to a timing, and electrically coupled to said segment electrodes via a plurality of segment circuits;
a multi-color modulation backlight unit having at least two different-color backlight sources; and
a multi-color backlight modulation device having a plurality of input junctions, an output junction and at least two backlight output control junctions,
wherein the number of said backlight output control junctions is identical to the number of said different-color backlight sources, and
wherein said multi-color backlight modulation device generates color-separation backlight control signals, and
wherein the assembly of said input junctions is electrically coupled to said output junction, and
wherein said single-level driving controller is electrically coupled to said input junctions of said multi-color backlight modulation device via a plurality of common circuits, and
wherein said output junction of said multi-color backlight modulation device is electrically coupled to said common electrode via a common-assembly circuit, and
wherein said backlight output control junctions are electrically coupled to said different-color backlight sources.

2. The chromatic liquid crystal display device according to claim 1, wherein said monochromatic LCD panel also has a plurality of mono-pixels corresponding to coincidence points of said common electrode and said segment electrodes.

3. The chromatic liquid crystal display device according to claim 2, wherein said segment voltage signals and said common voltage signals cooperate to form voltage differences driving said mono-pixels.

4. A method to realize a chromatic liquid crystal display device comprising steps:
preparing a monochromatic LCD (Liquid Crystal Display) panel having a common electrode and a plurality of segment electrodes, wherein said common electrode and said segment electrodes are respectively arranged on an upper layer and a lower layer;
preparing a multi-color modulation backlight unit having at least two different-color backlight sources;
preparing a single-level driving controller sequentially generating a plurality of common voltage signals and a plurality of segment voltage signals according to a timing, and electrically coupled to said segment electrodes via a plurality of segment circuits;
preparing a multi-color backlight modulation device having a plurality of input junctions, an output junction and at least two backlight output control junctions, wherein the number of said backlight output control junctions is identical to the number of said different-color backlight sources, and wherein said multi-color backlight modulation device generates color-separation backlight control signals, and wherein the assembly of said input junctions is electrically coupled to said output junction; and
electrically coupling said single-level driving controller to said input junctions of said multi-color backlight modulation device via a plurality of common circuits; electrically coupling said output junction of said multi-color backlight modulation device to said common electrode via a common-assembly circuit; electrically coupling said backlight output control junctions to said different-color backlight sources.
